(19) United States
(12) Patent Application Publication
(10) Pub. No.: US 2008/0230348 A1
(43) Pub. Date: Sep. 25, 2008

(54) Star Wheel

(76) Inventor: Franciscus Antonius Damen, Langeweg (NL)

Correspondence Address: The BOC Group, Inc., 575 MOUNTAIN AVENUE, MURRAY HILL, NJ, 07974-2082, US

(21) Appl. No.: 10/593,675

(22) PCT Filed: Mar. 1, 2005
(86) PCT No.: PCT/GB2005/000781

§ 371 Date: Sep. 19, 2006

(30) Foreign Application Priority Data
Mar. 19, 2004 (GB) 0406230.3

(51) Int. Cl. B65G 47/84

(52) U.S. Cl. 198/459.2

(57) ABSTRACT

A conveyor system (10) comprises a star wheel (32) for receiving articles (14) from a first conveyor (12) and dispatching the articles to a second conveyor. The star wheel comprises first and second segments (44, 46) each having a perimeter adapted to receive articles to be conveyed. A first shaft (52) rotates the first segment (44) about an axis, and a second shaft (60) rotates the second segment (46) about the axis. In one embodiment, a torsion spring (64) resiliently connects the shafts (52, 60) together. The first shaft (52) is connected to a first drive for rotating the first and second shafts (52, 60) together about the axis. The second shaft (60) is connected to a clutch (72) arrangement for selectively connecting the second shaft (60) to a second drive for rotating the second shaft about the axis at a different speed from the first shaft, for example, in the event that the first drive is switched off. This enables the second segment (46) to continue to rotate during deceleration of the first segment and thereby to continue to convey articles to the second conveyor. The clutch arrangement (72) disconnects the second segment (46) from the second drive before it clashes with the first segment (44) or any articles (14) conveyed thereby, the torsion spring (64) automatically returning the second segment (46) to a predetermined position relative to the first segment (44) for subsequent rotation with the first segment when the first drive is switched on again.

The invention relates to a star wheel. In its preferred embodiment, the star wheel forms part of a conveyor system for conveying articles, for example, between stations of an in-line filling machine. The star wheel is particularly useful in a system where an upstream function has a start/stop characteristic and a downstream function requires articles to be delivered at a constant speed.

In-line filling machines for dispensing products, such as liquids and/or powders, into containers or vials typically include a conveyor system for conveying articles between stations. A filling station receives empty vials from the conveyor system, sequentially fills the vials with an accurate amount of one or more products and closes the thus-filled vials with closure members, for example, stoppers. Commercially available filling stations can operate at a speed of between 50 and 600 vials per minute. The conveyor system then conveys the closed vials to an inspection station which checks that the vials have been correctly filled. The inspection station may be a contact weighing machine, incorporating scales or the like to measure the weight of each of the vials, or a “non-contact check weighing” machine (NCCW), which employs magnetic resonance techniques to accurately establish the weight and quality of the contents of the vials at a speed of up to 600 vials per minute. A sealing station may also be provided downstream from the inspection station for sealing the vials.

In order to accurately establish that the vials have been correctly filled, an NCCW requires the vials to be monitored whilst being conveyed at a constant speed. However, conveyor systems often require to be stopped, for example, because the infeed of vials from upstream systems has been interrupted, because the stopper supply system has to be replenished, an error situation occurs or an operator has stopped the system. Stopping of the conveyor system is not instantaneous; it may take a number of seconds (or vials) for the conveyor system to halt when running at maximum speed. Similarly, it may take a number of seconds (or vials) for the conveyor to reach the desired running speed again when it is re-started. As a result, in the combined time that it takes for the conveyor system to decelerate from running speed to rest, and subsequently the time that it takes for the conveyor system to accelerate from rest back to the running speed, a number of filled vials may have passed through the NCCW, and so the weight and quality of the contents of those vials will not have been accurately determined. As a consequence, those vials are usually discarded.

It is an aim of at least the preferred embodiments of the present invention to seek to solve this problem and thus provide a conveyor system which can enable the performance of one station to be unaffected by the stopping and starting of another station.

In a first aspect, the present invention provides a star wheel for a conveyor system, the star wheel having a perimeter adapted to receive articles to be conveyed, first and second segments rotatable about a common axis at different speeds and means for controlling rotation of the segments so as to avoid clashing between one segment and the other segment or any articles conveyed thereby.

A star wheel typically receives containers or vials from a first conveyor and dispatches the vials to a second conveyor. In one embodiment, a first shaft rotates the first segment about the common axis, and a second shaft rotates the second segment about the common axis. A resilient means, for example, a torsion spring, resiliently connects the first shaft to the second shaft. Means are provided for connecting the first shaft to a first drive for rotating the first and second shafts about the common axis. This first drive is preferably also arranged to drive the first conveyor, or may be synchronous with a drive for that conveyor.

A clutch arrangement is connected to the second shaft for selectively connecting the second segment to a second drive. This second drive is preferably also arranged to drive the second conveyor, or may be synchronous with a drive for that conveyor. The clutch arrangement normally disconnects the second segment from the second drive to enable the segments to rotate at the same speed during normal operation of the conveyor system about the axis to transfer vials between the conveyors. In the event that the first drive is switched off for any reason, for example, for the replenishment upstream from the star wheel of empty vials, product(s) dispensed from a filling station, and/or stoppers, the clutch arrangement temporarily connects the second segment to the second drive. This enables the second segment to continue to rotate synchronously with the second conveyor so as to transfer vials to the second conveyor, and thus enables the second conveyor to continue to feed vials at a constant speed, during deceleration of the first segment. In order to prevent clashing between the segments when rotating at different speeds, the clutch arrangement disconnects the second segment from the second drive before it comes into contact with the first segment or any vials carried thereby, and the torsion spring returns the second segment to a predetermined position relative to the first segment.

Furthermore, given that the section of the conveyor system between the first segment and any station which receives vials from the second segment has been “cleared” of vials before the first drive is switched back on again, this can provide sufficient time when the first drive is switched on again for the conveyor system to reach its normal, constant running speed before any vials reach, for example, a weighing machine. Consequently, neither the deceleration nor the acceleration of the first drive influences the measurements made by the weighing machine.

In a second aspect, therefore, the present invention provides a star wheel for a conveyor system, the star wheel comprising first and second segments each having a perimeter adapted to receive articles to be conveyed, a first shaft for rotating the first segment about an axis, a second shaft for rotating the second segment about the axis, means for resiliently connecting the first shaft to the second shaft, means for connecting the first shaft to a first drive for rotating the first and second shafts together about the axis, and means for selectively connecting the second shaft to a second drive for rotating the second shaft about the axis at a different speed from the first shaft.

The second segment is preferably connected to the second drive when the second segment is at a predetermined angular position, and is preferably disconnected from the second drive following rotation of the second segment to a second predetermined angular position. This can enable the second segment to be disconnected from the second drive following dispatch of all of the vials carried thereby to the second conveyor but before the second segment has come into contact with the first segment or with any vials carried thereby.

In this embodiment, at least part of the first segment is axially spaced along the common axis from the second segment, and the first and second segments may be of different size. In the preferred embodiment, the first segment is larger than the second segment, but with the segments preferably defining, in plan view, an annular wheel so that the star wheel closely replicates the more conventional annular star wheels.

As is usual with star wheels, each segment has a plurality of article-engaging elements spaced about the periphery thereof. In the preferred embodiment, each element comprises a recess for receiving an article to be conveyed, although an alternative arrangement, for example an array of suction or magnetic holders, may be provided.

In the embodiment discussed above, the clutch arrangement selectively connects the second segment to the second drive so that vials can be conveyed to a weighing machine at a constant speed. In order to maintain synchronicity between the first segment and the first conveyor, the first segment is permanently connected to the first drive. This prevents any clashing between the recesses of the first segment and vials held by the first conveyor.

In an alternative embodiment, the control means comprises a first servo arrangement for selectively connecting the first segment to one of a first drive and a second drive to rotate the segment at a first speed, and a second servo arrangement for selectively connecting the second segment to the other of the first drive and the second drive to rotate the second segment at a second speed different from the first speed. In this second embodiment, the first and second servo arrangements are preferably arranged to synchronously change the drive to which each segment is connected, for example, such that the segment which is currently receiving vials from the first conveyor at any given moment is connected to the first drive, so as to prevent clashing between the recesses of that segment and vials held by the first conveyor, and the other segment is connected to the second drive, to prevent clashing between the second conveyor and the vials held by that segment.

The advantages of the first embodiment are also associated with this second embodiment, and so in a third aspect the present invention provides a star wheel for a conveyor system, the star wheel comprising first and second segments rotatable about a common shaft, each segment having a perimeter adapted to receive articles to be conveyed; a first servo arrangement for coupling the first segment to one of a first and a second drive, and a second servo arrangement for coupling the second segment to the other of the first and second drive, wherein the first and second servo arrangements are arranged to synchronously change the drive to which each segment is connected.

In a fourth aspect, the present invention provides apparatus for conveying articles from a first station to a second station, the apparatus comprising a star wheel as aforementioned, a first conveyor for conveying articles from the first station to the star wheel, a first drive for driving the first conveyor, a second conveyor for conveying articles from the star wheel to the second station, and a second drive for driving the second conveyor.

For use in the first embodiment, the first and second drives are arranged to drive the conveyors at the same speed. For use in the second embodiment, the first and second drives are arranged to drive the conveyors at different speeds.

The apparatus preferably comprises a second star wheel for transferring articles from the first conveyor to the first star wheel, and a third star wheel for transferring articles from the first star wheel to the second conveyor. The first drive is preferably arranged to rotate the second star wheel and the second drive is preferably arranged to rotate the third star wheel. In the first embodiment, the first star wheel is smaller than the second and third star wheels. In the second embodiment, the first star wheel is larger than the second and third star wheels.

Preferred features of the present invention will now be described, by way of example only, with reference to the accompanying drawings, in which:

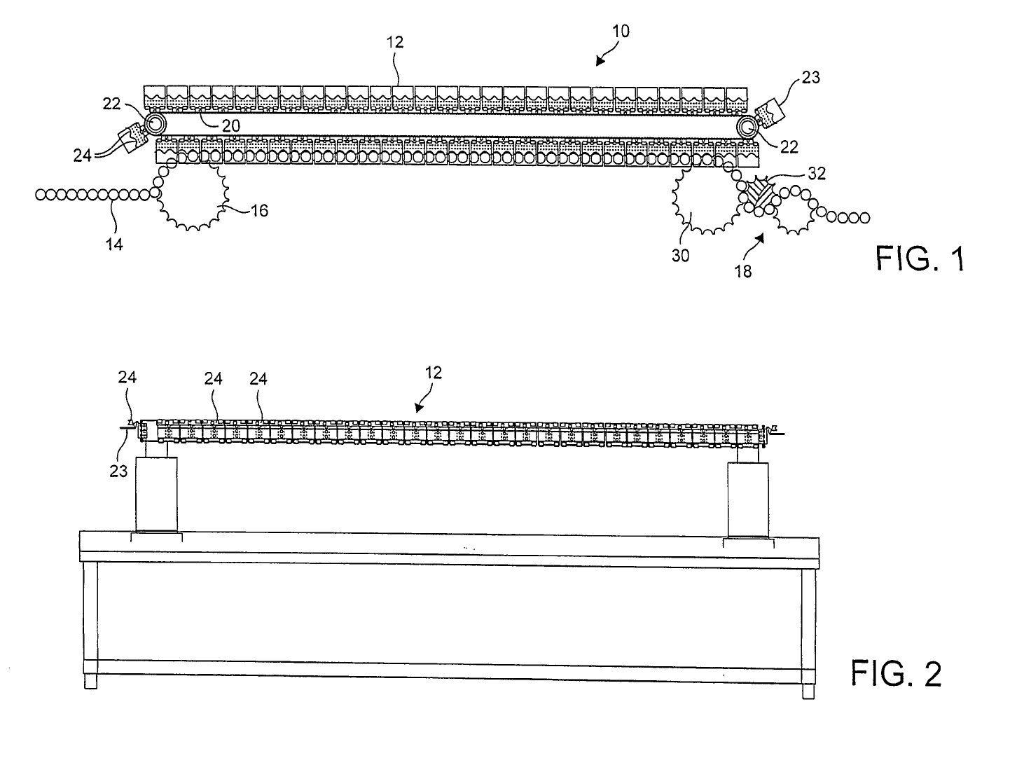

FIG. 1 illustrates a top view of part of a conveyor system;

FIG. 2 illustrates a side view of a conveyor of the conveyor system of FIG. 1;

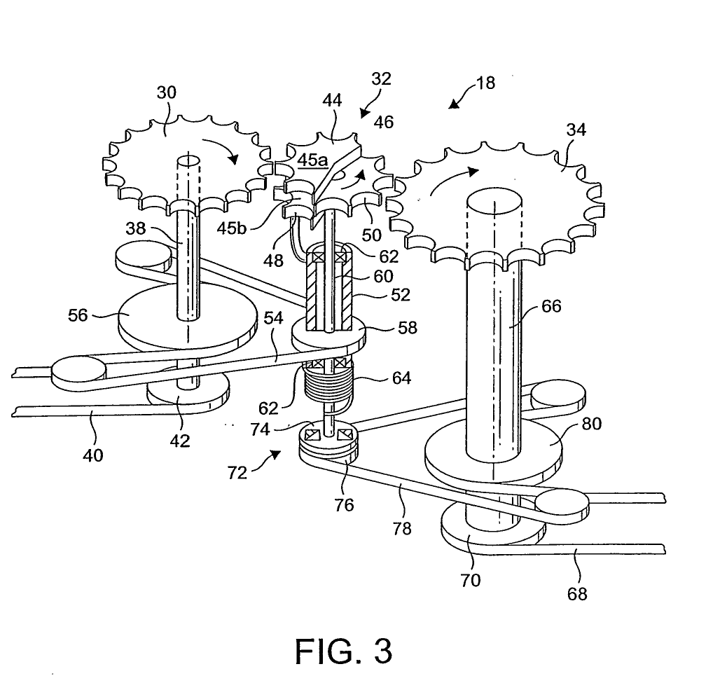

FIG. 3 illustrates a perspective view of a first embodiment of a magic star wheel;

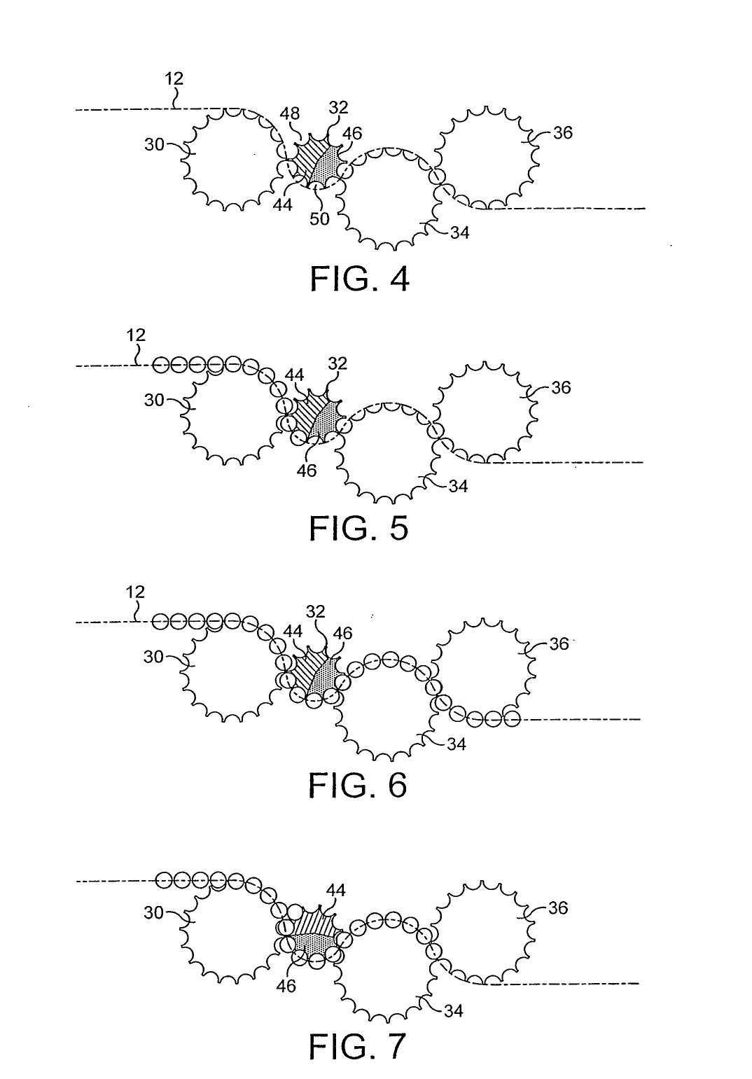

FIGS. 4 to 9 illustrate the operation of this first embodiment in a first arrangement of star wheels in a conveyor system;

FIG. 10 illustrates a second arrangement of star wheels;

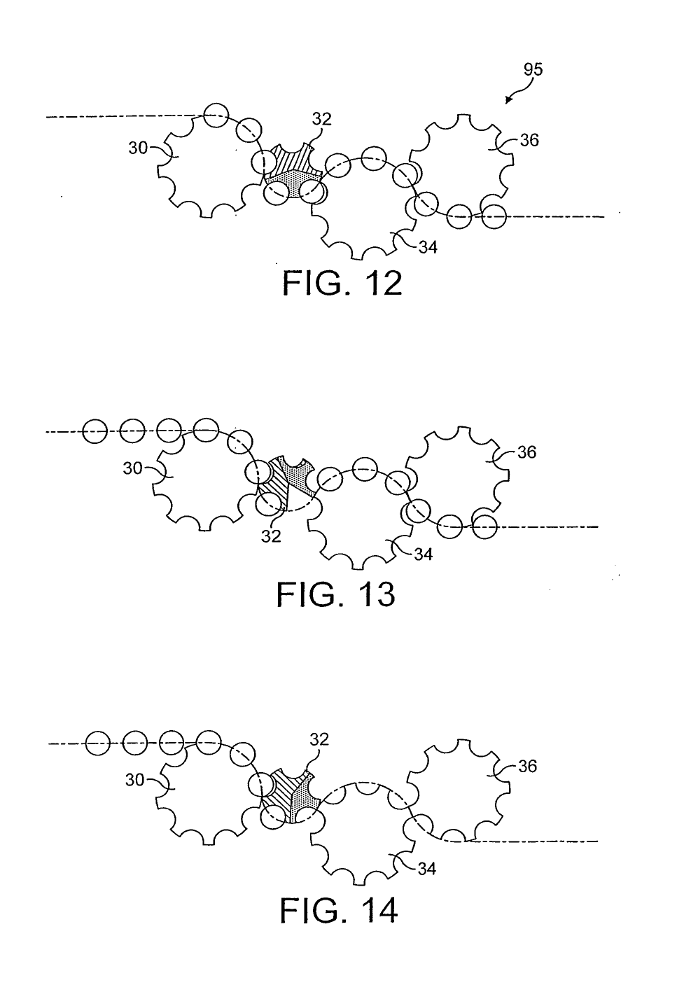

FIGS. 11 to 14 illustrate the operation of a third arrangement of star wheels;

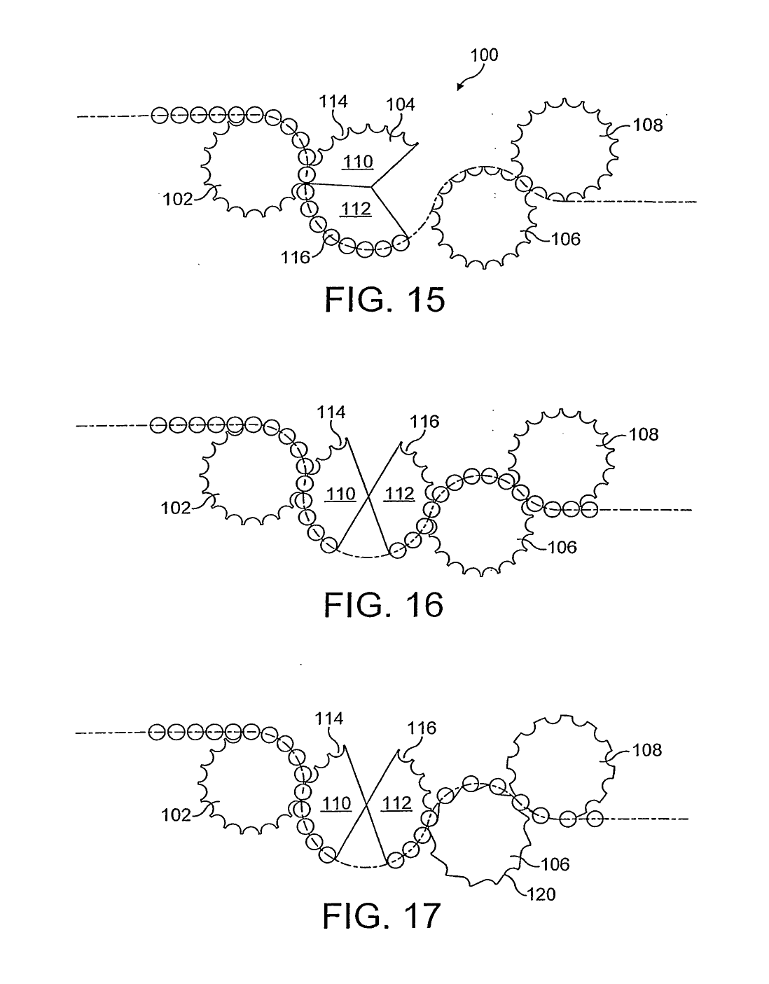

FIGS. 15 and 16 illustrate the operation of a fourth arrangement of star wheels; and

FIG. 17 illustrates a fifth arrangement of star wheels.

With reference first to FIG. 1, a conveyor system 10 for conveying vials between stations or functions comprises a conveyor 12 for receiving vials 14 from star wheel 16 and conveying the vials through a first station (not shown) to a star wheel arrangement 18 which transfers the vials from the conveyor 12 to a second, conveyor (not shown) for conveying the vials to the second station. As shown in FIGS. 1 and 2, the conveyor 12 comprises an endless chain 20 driven by motor-driven gear wheels 22 to move about a vertical axis. Vial tables 23 each having two vial-receiving recesses 24 are mounted on the chain 20 so that the recesses 24 have the same pitch as the recesses of the star wheel 16, the rotation of the chain 20 and the star wheel 16 being synchronised to ensure a smooth exchange of vials between the star wheel 16 and conveyor 12. Similarly, the recesses of star wheel 30 of the star wheel arrangement 18 have the same pitch as the recesses 24, rotation of the conveyor 12 and star wheel 30 also being synchronised to ensure a smooth exchange of vials between the conveyor 12 and star wheel arrangement 18.

FIG. 3 shows the star wheel arrangement 18 in more detail. The star wheel arrangement 18 comprises a first annular star wheel 30 for conveying vials from the conveyor 12 to a central “magic” star wheel 32, which transfers the vials received from star wheel 30 to a second annular star wheel 34 for subsequent transfer of the vials to the second conveyor. Each star wheel 30, 32, 34 has a number of vial-receiving recesses spaced about the periphery thereof for holding vials transferred thereto. The star wheel 34 may convey vials directly to the second conveyor or, as shown in FIG. 4, may convey vials to a third annular star wheel 36 for transferring the vials to the second conveyor.

The first star wheel 30 is rotated about a first shaft 38 by a timing belt 40 which couples a first timing pulley 42 of the first shaft 38 to a timing pulley (not shown) rotated by a first drive (not shown). In this embodiment, this first drive is provided by the motor which drives the gear wheels 22 of the conveyor 12, or alternatively the drive may be another motor synchronously driven with that motor.

The magic star wheel 32 comprises a first segment 44 and a second segment 46. The first segment 44 comprises upper and lower axially spaced parts 45a, 45b of similar size and shape. The second segment 46 is co-planar with the spacing between the parts 45a, 45b of the first segment 44. The parts 45a, 45b may be separate parts joined by any suitable means, for example, rods, which does not interfere with the entry of the second segment 46 between the parts 45a, 45b of the first segment 44, as described below, or may be formed from a single piece of material machined to form the spacing between the two parts 45a, 45b. Forming the first segment 44 from two axially spaced parts assists in providing stability to transported vials.

Each segment 44, 46 has a plurality of recesses 48, 50 spaced about the periphery thereof, the size and pitch of the recesses 48 of the first segment 44 being the same as those of the recesses 50 of the second segment 46. In this embodiment, the recesses of the annular star wheels 30, 34, 36 have the same pitch as the recesses 48, 50 of the magic star wheel 32. In the rest position shown in FIG. 4, the segments 44, 46 define in plan view a two-part annular wheel, with substantially no overlap between the segments 44, 46.

The first segment 44 is rotated about the common axis by a second shaft 52 co-axial with the common axis. The second shaft 52 is connected to the first shaft 38 by a timing belt 54 coupling a second timing pulley 56 of the first shaft 38 to a timing pulley 58 of the second shaft 52, so that the first and second shafts 38, 52 rotate synchronously during use of the star wheel arrangement 18.

The second segment 46 is rotated about the common axis by a third shaft 60 co-axial with the second shaft 52 and located relative thereto by bearings 62. The second and third shafts 52, 60 are connected together by a torsion spring 64 to enable the shafts 52, 60 to rotate synchronously about the common axis.

The second annular star wheel 34 is rotated about a fourth shaft 66 by a timing belt 68 which couples a first timing pulley 70 of the fourth shaft 66 to a timing pulley (not shown) rotated by a second drive (not shown). In this embodiment, this second drive is provided by the motor which drives the second conveyor, or alternatively the drive may be another motor synchronously driven with that motor.

A clutch arrangement 72 is provided at the end of the third shaft 60 for selectively connecting the third shaft 60 to fourth shaft 66 and thus to the second drive. The clutch arrangement 72 comprises a solenoid clutch 74 actuable by a control device (not shown) to engage a timing pulley 76 rotated by a timing belt 78 coupled to a second timing pulley 80 of the fourth shaft 66.

In this embodiment, the first and fourth shafts 38, 66 are rotated at the same speed.

The operation of a first embodiment of the star wheel arrangement 18 will now be described with reference to FIGS. 4 to 9.

In the rest position shown in FIG. 4, the first and second segments 44, 46 are each in predetermined angular positions. In these positions, the first and second segments are in a non-overlapping alignment such that both segments 44, 46 define in plan view an annular star wheel with recesses of constant pitch. The recesses 48 of the first segment 44 are aligned with the recesses of the first star wheel 30, and the recesses 50 of the second segment 46 are aligned with the recesses of the second star wheel 34. In this position, the clutch arrangement 72 disconnects the third shaft 60 from the fourth shaft 66 so that when the conveyor system is started, the drive for the first conveyor 12 rotates the first star wheel 30 and both segments 44, 46 of the magic star wheel 32, and the drive for the second conveyor rotates the second and third star wheels 34, 36.

With the conveyor system 10 in operation, vials conveyed by the first conveyor 12 are transferred to the first star wheel 30, which, as shown in FIG. 5, initially transfers vials to the first segment 44 of the magic star wheel 32 and, with subsequent further rotation of the star wheel arrangement 12, to the second segment 46, so that the segments 44, 46 sequentially receive vials from the first star wheel 30 and transfer those vials to the second star wheel 34, which, as shown in FIG. 6, transfers vials to the third star wheel 36 for conveyance to the second conveyor. In this embodiment the first and second segments 44, 46 are of different size, the segments being shaped so that when the second segment 46 is positioned to start to receive vials from the first star wheel 30, it carries no vials, as any vials previously transferred thereto from the first star wheel 30 have already been transferred to the second star wheel 34.

In the event that the drive for the first conveyor 12 is stopped, the conveyor 12 is not decelerated from the normal running speed until the star wheel arrangement 18 is in the position shown in FIG. 7, in which the second segment 46 is “full”, that is, when all of the recesses 50 of the second segment 46 hold a vial. In that position, the control device actuates the solenoid clutch 74 to engage the pulley 76 so that the third shaft 60 is rotated by the second drive to enable the second segment 46 to continue to rotate about the common axis at a constant speed. Simultaneously, the drive for the first conveyor 12 commences deceleration of the chain 20, first star wheel 30 and the first segment 44 of the magic star wheel 32 so that the first segment 44 is stopped in the position shown in FIG. 5.

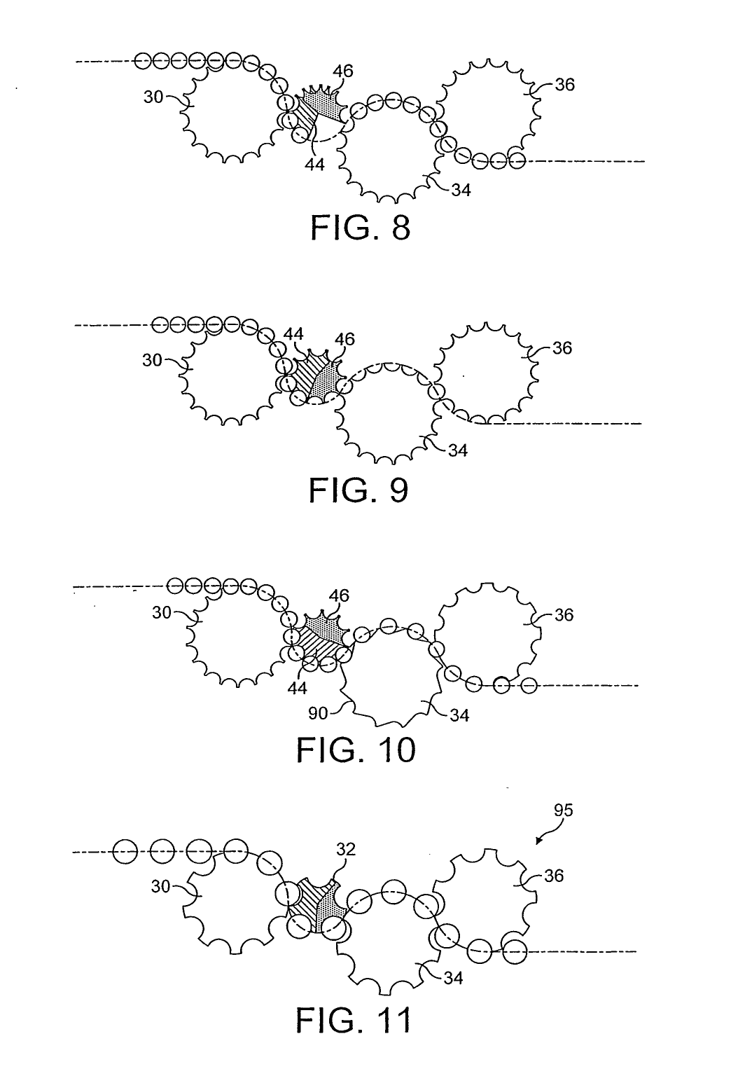

As shown in FIG. 8, continued rotation of the second segment 46 enables that segment 46 to dispatch to the second star wheel 34 all of the vials carried thereby when the first conveyor 12 was switched off. Once all of the recesses 50 have been emptied, and the second segment 46 has been rotated between the parts 45a, 45b of the first segment 44 to the position shown in FIG. 8, rotation of the second segment 46 is stopped in order to prevent clashing of the rotating second segment 44 with the vials held by either the stationary first star wheel 30 or the stationary first segment 44. The control device controls the clutch arrangement 72 to disconnect the solenoid clutch 74 from the pulley 76 to enable the second segment 46 to be spring loaded back to the position shown in FIG. 9 by the torsion spring 64 (which had become elastically deformed during the rotation of the second segment relative to the first segment) so that the alignment of the first and second segments 44, 46 is the same as in the rest position shown in FIG. 4. With the first star wheel 30 and the magic star wheel 32 now stationary, the second and third star wheels 34, 36 convey the remaining vials held thereby to the second conveyor.

In view of the uninterrupted, constant rotation of the second segment 46 during the deceleration of the first conveyor 12, and the uninterrupted, constant rotation of the second and third star wheels 34, 36, the second conveyor continues to feed vials to, for example, a weighing machine, at a constant speed.

Furthermore, given that the section of the conveyor system 10 between the first segment and any station which receives vials from the second conveyor has been “cleared” of vials before the drive for the first conveyor 12 has been switched back on again, this can provide sufficient time for the conveyor system 10 to accelerate from rest back up to its normal, constant running speed before any vials reach the weighing machine. Consequently, neither the deceleration nor the acceleration of any part of the conveyor system 10 influences the measurements made by the weighing machine.

In the star wheel arrangement shown in FIGS. 4 to 9, the recesses of the first, second and third annular star wheels 30, 34, 36 and the magic star wheel 32 have the same pitch, for example, ±40 mm. However, the star wheel arrangement can also be used to change the pitch of the vials between the first and second conveyors. For example, in an alternative arrangement shown in FIG. 10, the recesses of the third star wheel 36 has an increased pitch, for example, ±60 mm, the second star wheel 34 having recesses 90 shaped to increase the pitch of vials received from the magic star wheel 32 from ±40 mm to ±60 mm. Otherwise, the operation of this star wheel arrangement is the same as that of the star wheel arrangement 18 described with reference to FIGS. 4 to 9.

The star wheel arrangement can be used with pitches other than ±40 mm. For example, FIGS. 11 to 14 illustrate the operation of a star wheel arrangement 95 where the pitch of the recesses of the first, second and third annular star wheels 30, 34, 36 and the magic star wheel 32 is ±80 mm. The positions of the star wheels in the star wheel arrangement 95 shown in FIGS. 11 to 14 correspond to the positions of the star wheel arrangement 18 shown in FIGS. 6 to 9 respectively, and therefore are not described in more detail here.

In each of the arrangements described above with reference to FIGS. 4 to 14, the shaft 38 of the first annular star wheel 30 is rotated at the same speed as the shaft 66 of the second annular star wheel 34. FIGS. 15 and 16 illustrate the operation of an embodiment of a star wheel arrangement 100 in which the shafts 38, 66 are rotated at different speeds to accommodate for the different speeds of the first and second conveyors.

With reference first to FIG. 15, the star wheel arrangement 100 comprises a first annular star wheel 102 rotating at a first speed for receiving vials from a first conveyor and conveying those vials to a central “magic” star wheel 104, which transfers the vials to a second annular star wheel 106 rotating at a second speed different from the first speed. The second star wheel 106 may convey vials directly to a second conveyor or, as shown in FIG. 15, may convey vials to a third annular star wheel 108 for transferring the vials to the second conveyor.

The magic star wheel 104 comprises a first segment 110 and a second segment 112 spaced from the first segment 110 along a common axis about which the segments rotate during use of the star wheel arrangement 100. Each segment 110, 112 is of the same size and has the same number of recesses 114, 116 spaced about the periphery thereof, the size and pitch of the recesses 114 of the first segment 110 being the same as those of the recesses 116 of the second segment 112. In this embodiment, the recesses of the annular star wheels 102, 106, 108 have the same size as the recesses 114, 116 of the magic star wheel 104.

The first segment 110 is selectively connected by a first servo arrangement to one of the drive shaft for the first star wheel 102 and the drive shaft for the second star wheel 106, and the second segment 112 is selectively connected by a second servo arrangement to the other one of the drive shaft for the first star wheel 102 and the drive shaft for the second star wheel 106. Consequently, at any given moment during normal running of the star wheel arrangement 100, one of the segments 110, 112 is rotating at the first speed and the other segment is rotating at the second speed.

In this embodiment, the drive shaft for the first star wheel 102 is driven by the motor which drives the first conveyor, or alternatively the drive may be another motor synchronously driven with that motor. Similarly, the drive shaft for the second star wheel 106 is driven by the motor which drives the second conveyor, or alternatively the drive may be another motor synchronously driven with that motor.

The servo arrangements for the first and second segments 110, 112 are arranged such that the segment which is receiving vials from the first, slower star wheel 102 is connected to the drive shaft for that star wheel 102, and the segment which is dispatching vials to the second, faster star wheel 106 is connected to the drive shaft for that star wheel 106. The segments 110, 112 are shaped so that a segment does not receive vials from the first star wheel 102 whilst dispatching vials to the second star wheel 106. For example, in FIG. 15, the second segment 112 has just been connected to the drive shaft for the second star wheel 106 so as convey the vials located in the recesses thereof to the second star wheel 106, and the first segment 110 has just been connected to the drive shaft for the first star wheel 102 so as to receive vials in the empty recesses thereof. This also serves to prevent clashing between the segments or between one of the segments and any vials conveyed by the other segment. As the second segment 112 will subsequently rotate at a faster speed than the first segment 110, the connections of the first and second segments will be switched when the positions of the segments in FIG. 15 have been reversed.

This second embodiment also shares the advantages of the first embodiment described above. When the drive for the first star wheel 102 is switched off, rotation of the first star wheel 102 and the magic star wheel 104 is continued as normal until the magic star wheel 104 is in the position shown in FIG. 15, that is, with the one of the segments (either, as shown in FIG. 15, the first segment 110 or, depending on exactly when the drive was switched off, the second segment 112) “empty” and having just been connected to the first drive to receive vials from the first star wheel, and the other segment “full” and having just been connected to the second drive to convey vials to the second star wheel 106. In this position, deceleration of the first star wheel 102 and the first segment 110 commences until the first star wheel 102 and the first segment 110 are in the rest positions shown in FIG. 16. The second segment 112 continues to rotate about the common shaft until all vials carried thereby have been dispatched to the second star wheel 106, at which point the second segment 112 is disconnected from the second drive and, as in the star wheel arrangement 18, rapidly returned to a rest position proximate the first segment 108.

In the star wheel arrangement shown in FIGS. 15 and 16, the recesses of the first, second and third annular star wheels 102, 106, 108 and the magic star wheel 104 have the same pitch, for example, ±40 mm. However, the star wheel arrangement can also be used to change the pitch of the vials between the first and second conveyors. For example, in an alternative arrangement shown in FIG. 17, the recesses of the third star wheel 108 has an increased pitch, for example, ±60 mm, the second star wheel 106 having recesses 120 shaped to increase the pitch of vials received from the magic star wheel 104 from ±40 mm to ±60 mm. Otherwise, the operation of this star wheel arrangement is the same as that of the star wheel arrangement 110 described with reference to FIGS. 15 and 16.

1. A star wheel for a conveyor system, the star wheel comprising a first and second segment, each segment having a perimeter adapted to receive articles to be conveyed, the segments being rotatable about a common axis at different speeds and a control means for controlling rotation of the segments so as to avoid clashing between one segment and the other segment or any articles conveyed thereby.

2. The star wheel according to claim 1, wherein the control means comprises a first shaft for rotating the first segment about the common axis, a second shaft for rotating the second segment about the common axis, and a resilient means for resiliently connecting the first shaft to the second shaft.

3. The star wheel according to claim 2, wherein the control means comprises a connect means for connecting the first shaft to a first drive for rotating the first and second shafts about the common axis, and a select means for selectively connecting the second shaft to a second drive for rotating the second shaft about the common axis at a different speed from the first shaft.

4. The star wheel according to claim 3, wherein the control means comprises a clutch arrangement for selectively connecting the second shaft to, and disconnecting the second shaft from, the second drive.

5. The star wheel according to claim 4, wherein the clutch arrangement is arranged to connect the second shaft to the second drive upon deceleration of the first shaft.

6. The star wheel according to claim 4, wherein the clutch arrangement is arranged to connect the second shaft to the second drive when the second segment is at a first predetermined angular position.

7. The star wheel according to claim 6, wherein, to prevent said clashing, the clutch arrangement is arranged to disconnect the second shaft from the second drive following rotation of the second segment to a second predetermined angular position relative to the first segment.

8. The star wheel according to claim 7, wherein the resilient means is arranged to return the second segment from the second angular position to the first-mentioned angular position upon disconnection of the second shaft from the second drive.

9. The star wheel according to claim 4, wherein the clutch arrangement comprises a solenoid clutch actuable to selectively engage a disc rotated by the second drive.

10. The star wheel according to claim 2, wherein the resilient means comprises a torsion spring connecting the first shaft to the second shaft.

11. The star wheel according to claim 1, wherein at least part of the first segment is axially spaced from the second segment along the common axis.

12. The star wheel according to claim 1, wherein the first and second segments are of different size.

13. The star wheel according to claim 12, wherein, in plan view, the segments define an annular wheel.

14. The star wheel according to claim 1, wherein each segment has a plurality of article-engaging elements spaced about the periphery thereof.

15. The star wheel according to claim 14, wherein each element comprises a recess for receiving an article to be conveyed.

16. The star wheel according to claim 14, wherein the segments have different numbers of said elements.

17. A star wheel for a conveyor system, the star wheel comprising first and second segments each having a perimeter adapted to receive articles to be conveyed, a first shaft for rotating the first segment about an axis, a second shaft for rotating the second segment about the axis, a resilient means for resiliently connecting the first shaft to the second shaft, a connect means for connecting the first shaft to a first drive for rotating the first and second shafts together about the axis, and a select means for selectively connecting the second shaft to a second drive for rotating the second shaft about the axis at a different speed from the first shaft.

18. The star wheel according to claim 1, wherein the control means comprises a first servo arrangement for selectively connecting the first segment to one of a first drive and a second drive to rotate the segment at a first speed, and a second servo arrangement for selectively connecting the second segment to the other of the first drive and the second drive to rotate the second segment at a second speed different from the first speed.

19. The star wheel according to claim 18, wherein the first and second servo arrangements are arranged to synchronously change the drive to which the segments are connected to prevent said clashing.

20. A star wheel for a conveyor system, the star wheel comprising a first and second segment that are rotatable about a common axis, each segment having a perimeter adapted to receive articles to be conveyed, a first servo arrangement for connecting the first segment to one of a first and a second drive, and a second servo arrangement for connecting the second segment to the other of the first and second drive, wherein the first and second servo arrangements are arranged to synchronously change the drive to which each segment is connected.

21. An apparatus for conveying articles from a first station to a second station, the apparatus comprising a star wheel according to claim 1, a first conveyor for conveying articles from the first station to the star wheel, a first drive for driving the first conveyor, a second conveyor for conveying articles from the star wheel to the second station, and a second drive for driving the second conveyor.

22. The apparatus according to claim 21, wherein the first and second drives are arranged to drive the conveyors at the same speed.

23. The apparatus according to claim 21, wherein the first and second drives are arranged to drive the conveyors at different speeds.

24. The apparatus according to claim 21, comprising a second star wheel for transferring articles from the first conveyor to the first star wheel, and a third star wheel for transferring articles from the first star wheel to the second conveyor.

25. The apparatus according to claim 24, wherein the first drive is arranged to rotate the second star wheel and the second drive is arranged to rotate the third star wheel.

26. The apparatus according to claim 24, wherein the first star wheel is smaller than the second and third star wheels.

27. The apparatus according to claim 24, wherein the first star wheel has a smaller number of article-engaging elements than either the second or the third star wheel.

28. The apparatus according to claim 24, wherein the third star wheel has a smaller number of article-engaging elements than the second star wheel.
